(19) United States
(12) Patent Application Publication
(10) Pub. No.: US 2010/0133399 A1
(43) Pub. Date: Jun. 3, 2010

(54) RECEPTACLE HANGER

(76) Inventors: Sandro Zaccolo, Toronto (CA); H.T. Martin Ditchburn, Oakville (CA)

Correspondence Address: GEORGE A. SEABY;SEABY & ASSOCIATES, 250 CITY CENTRE AVNUE, OTTAWA, ON, K1R6K7, CA

(21) Appl. No.: 12/452,287

(22) PCT Filed: Jun. 27, 2008
(86) PCT No.: PCT/CA2008/001194

§ 371 Date: Dec. 23, 2009

(51) Int. Cl. A47G 29/00; F16M 13/02

(52) U.S. Cl. 248/220.21; 248/311.2

(57) ABSTRACT

A receptacle hanger includes a planar body with a generally L-shaped rails extending upwardly and outwardly from a top edge thereof. Triangular reinforcing gussets extend between the front surface of the body and bottom arms of the rails. The body is attached to a vertical surface with the rails extending outwardly and upwardly therefrom. A receptacle with a flange or lip extending outwardly and downwardly therefrom is suspended from the hanger by placing the flange over the rails.

### BACKGROUND OF THE INVENTION

This invention relates to a receptacle hanger, and in particular to a hanger for use with a receptacle having a flange or lip extending outwardly and downwardly from the upper end thereof.

### FIELD OF THE INVENTION

The hanger of the present invention is designed for use with a variety of residential and commercial receptacles having a circumferential flange or lip. By suspending the receptacles, floor space is freed up. Typical receptacles which can be suspended on a vertical surface using the hanger of the present invention include receptacles for municipal recycling programs, garbage and compost collection receptacle, receptacle for the collection, sorting and storage of children's toys, laundry and other lightweight items, tub-like receptacles such as flower planters, animal feeding troughs and receptacles for sorting mail, packages, parcels and documents.

Typically, receptacles of the above-mentioned type are placed on elaborate and costly shelving systems or on a plurality of individual J-shaped hooks which require significant effort to properly install in horizontal alignment with adequate spacing and anchorage to wall structures, particularly when mounting on plasterboard or drywall. The basic problem associated with installing hooks is the finding of studs, which are typically spaced apart by approximately 40.6 cm from center to center. In order to mount a minimum of two hooks required to properly support a container, it is necessary to locate two adjacent studs and ensure that there is a horizontal line between the studs. This hook spacing will accommodate a range of receptacles longer than 40.6 cm, but does not allow smaller receptacles to be supported by hooks fastened to wall studs alone. This configuration also does not allow the mounting of a container in close proximity to an access door while maintaining sufficient distance so as not to obstruct through traffic. An alternative is to install three hooks to support a container with the middle hook secured to a wall stud and adjacent hooks drywall anchored. However, this requires precisely aligning three J-hooks horizontally to ensure the middle hook properly bears the container weight. This leaves the two outer hooks solely anchored to drywall for secondary support and maintaining balance while preventing container side-to-side rocking which may occur with a non-uniformly loaded container. Thus, the strength of the drywall alone is relied upon which may fail with normal continued use.

As a result of the above-described conventional container placement options, it is difficult to wall mount individual containers. Accordingly, containers are either stacked on top of each other on a floor which may or may not be possible because some receptacles are typically over filled or do not posses a lid top to accept another such container. Purchasing and assembling shelving systems involving brackets, braces and structural support members further adds to container storage problems which often result in placing receptacles side-by-side on a floor taking up valuable space which may be better used for more appropriate items or simply a less cluttered space.

### BRIEF SUMMARY OF THE INVENTION

An object of the present invention is to solve the above-identified problems and drawbacks of conventional container storage systems by providing a one-piece hanger which can easily be mounted on one stud or other vertical support.

Other objects of the invention are:

(i) to provide a receptacle hanger which is relatively inexpensive to manufacture, durable and lightweight;

(ii) to provide a receptacle hanger which is quickly and easily installed using ordinary tools and fasteners, and

(iii) to provide a receptacle hanger which is adaptable to fit a range of receptacle sizes and configurations.

Yet another object of the invention is to provide a receptacle hanger which is capable of supporting a load of up to 27 kilograms.

Accordingly, the invention relates to a receptacle hanger comprising:

(a) an elongated, planar body for mounting on a vertical surface; and

(b) at least one rail extending upwardly and outwardly from an upper end of said body for engaging a flange extending outwardly and downwardly from the receptacle, whereby the suspended receptacle is suspended from the hanger.

As used herein, “receptacle” is intended to mean any container, such as a bin, box, frame, or bag used for storage or collection, and the expression “flange” is intended to mean a lip or rim which can be placed on the hanger rail(s) to suspend the receptacle from the hanger.

The receptacle hanger of the present invention can be used on most interior and exterior wall structures while resisting atmosphere and environmental degradation. The receptacle hanger is removable and reusable, and can be mounted on different wall structures such as drywall, masonry, concrete, wood, metal and plastic.

The receptacle hanger can be formed from a variety of materials including plastic, a metal such as aluminum, a polymer and wood.

### BRIEF DESCRIPTION OF THE DRAWINGS

FIG. 1 is a front perspective view of a receptacle hanger in accordance with the present invention;

FIG. 2 is a front view of the hanger of FIG. 1;

FIG. 3 is a rear view of the hanger of FIGS. 1 and 2;

FIG. 4 is an end view of the hanger of FIGS. 1 to 3;

FIG. 5 is a cross section taken generally along line 5-5 of FIG. 2;

FIG. 6 is a top view of the hanger of FIGS. 1 to 4;

FIG. 7 is a perspective view of a section of a wall carrying the hanger;

FIG. 8 is a front view of the wall section, hanger and receptacle shown in FIG. 7;

FIG. 9 is a cross section taken generally along line 9-9 of FIG. 8 of the wall section, the hanger and an upper end of the receptacle;

FIG. 10 is a perspective view of a section of a receptacle mounted on the hanger; and

FIG. 11 is a perspective view of a section of the wall with two receptacles mounted thereon.

### DETAILED DESCRIPTION OF THE INVENTION

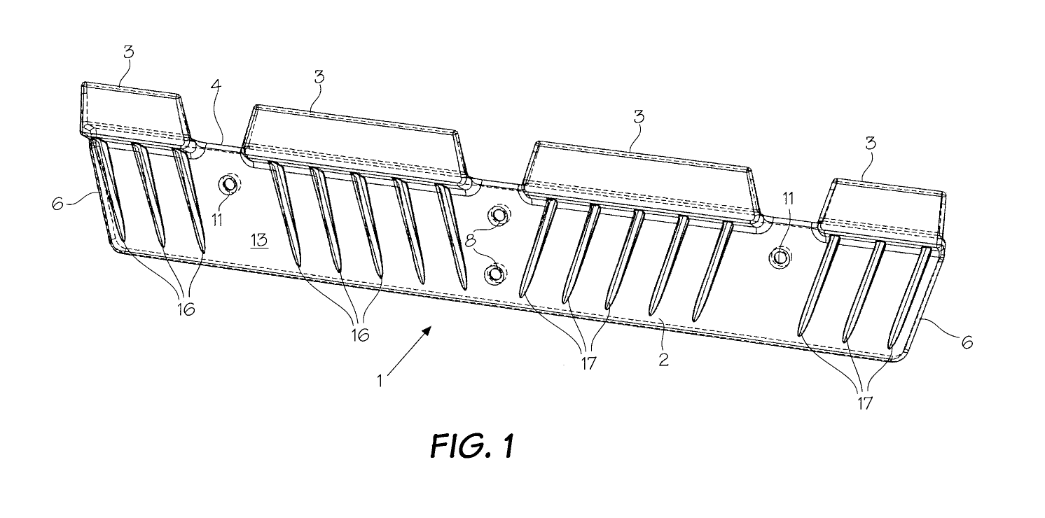

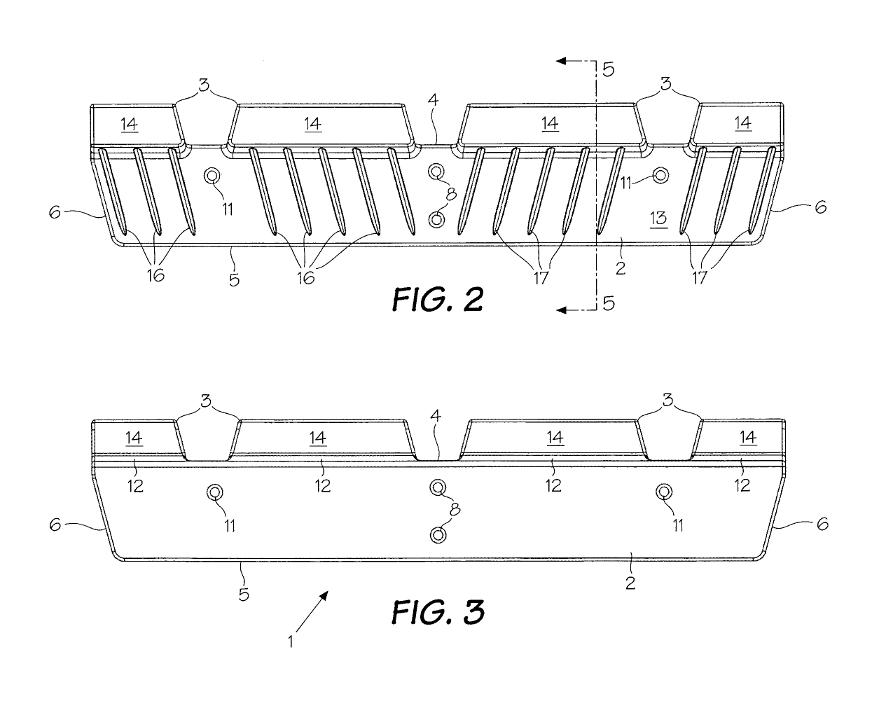

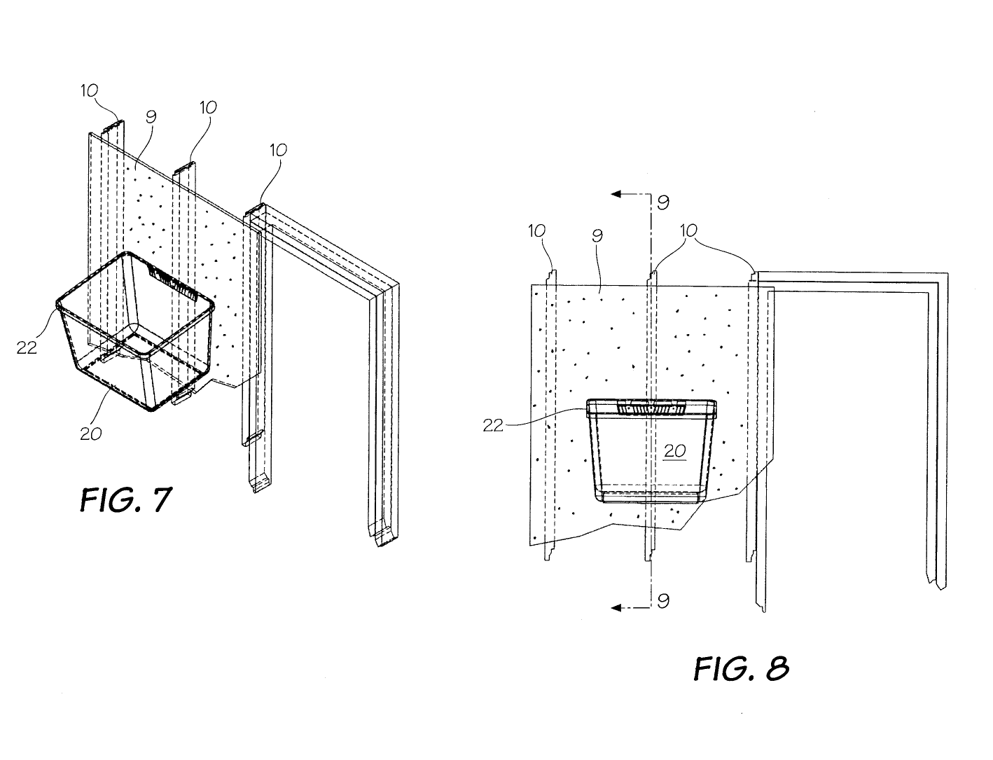

Referring to FIGS. 1 to 6, a receptacle hanger according to the invention which is indicated generally at 1 includes a planar body 2 with a plurality of spaced apart rails of fingers 3 extending upwardly from the upper edge 4 thereof. As best shown in FIGS. 2 and 3, the body 2 is trapezoidal with parallel upper and lower edges 4 and 5, respectively, and side edges 6 inclined downwardly and inwardly from the upper to the lower edge. A pair of vertically aligned holes 8 are provided in the center of the body 2 for receiving screws or other fasteners (not shown) when mounting the hanger on a wall 9 (FIGS. 7 to 9 and 11). The holes 8 are vertically aligned so that a pair of screws can be inserted into a single stud 10 resulting in secure mounting and the ability to carry a heavy load. Additional holes 11 in the body 2 between the center and side edges 6 thereof receive screws (not shown) which force the ends of the body against the wall 9.

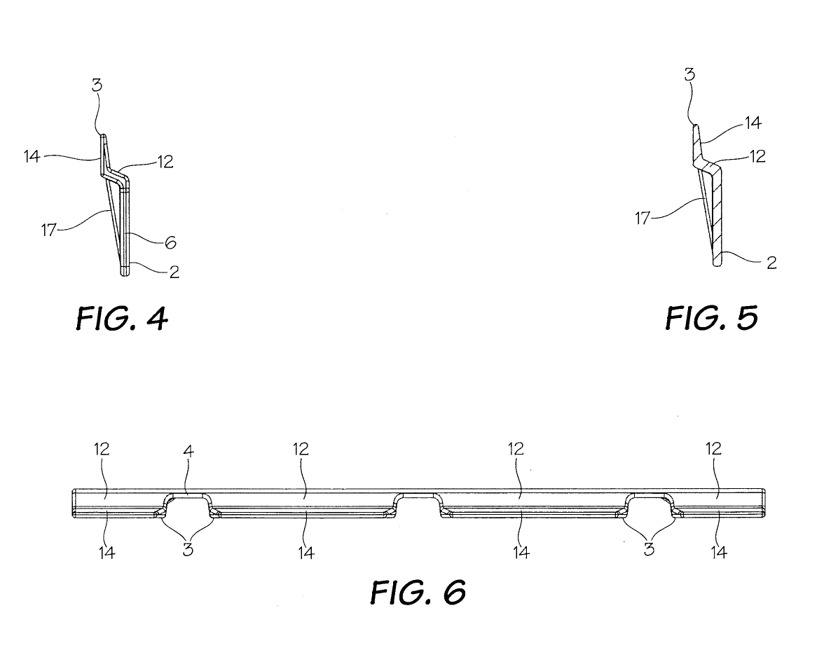

As best shown in FIGS. 4 and 5, the rails 3 are generally L-shaped and include an inclined lower arm 12 extending outwardly and upwardly from the front surface 13 of the body 2. A vertical arm 14 of each rail 3 tapers upwardly from the outer end of the arm 12. Inclined, triangular reinforcing gussets 16 and 17 extend between the bottom of the lower gusset arms 12 and the front surface 13 of the body 2. The gussets 16 on one side of center are inclined and parallel to one end 6 of the body 2, and the gussets 17 on the other side of center are inclined and parallel to the other end 6 of the body. This arrangement of the gussets 16 and 17 strengthens the hanger, preventing twisting of the body 2 around its longitudinal or transverse axis.

With reference to FIGS. 7 to 9, when mounting the hanger on a wall 7 it is merely necessary to find one stud 8. Screws (not shown) pass through the central holes 6 into the stud 8, and additional screws pass through holes 9 on each side of the body 2 into suitable expansible anchors in the walls. In the case of a wooden wall, it may not be necessary to find a stud 8. When the wall is formed of masonry, concrete, metal or plastic, it may be necessary to use expansible anchors or self tapping screws.

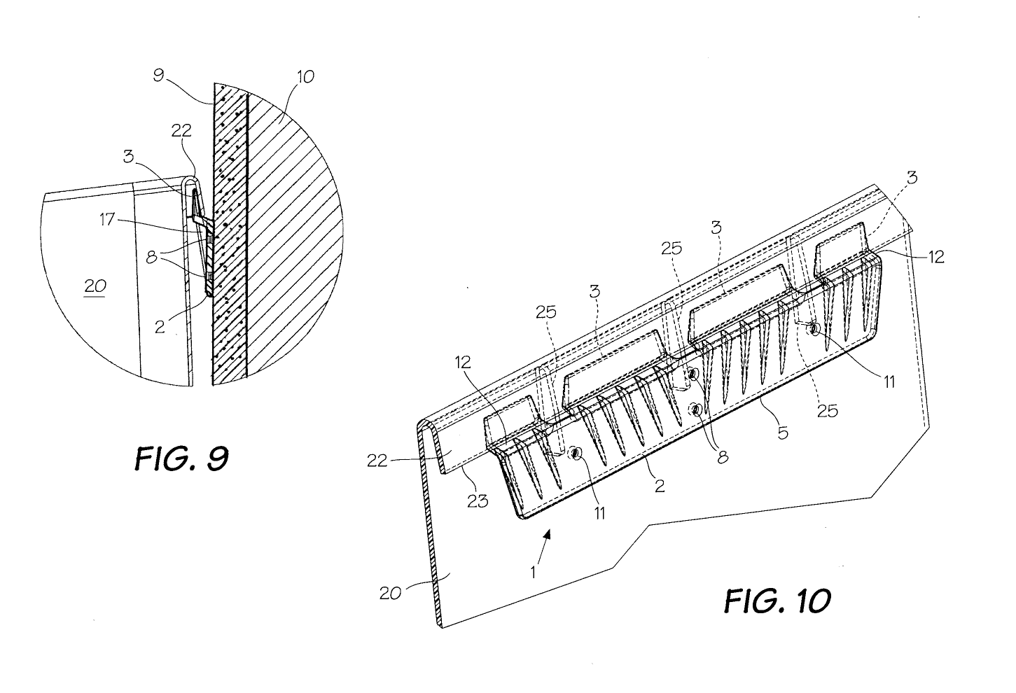

Once the hanger 1 has been installed, it is a simple matter to suspend a receptacle 20 therefrom. As best shown in FIGS. 9 and 10, the receptacle 20 in this case has an outwardly and downwardly extending flange or lip 22 around the periphery of the upper end thereof. The lip 22 is slipped over the rails 3 so that the bottom edge 23 (FIG. 10) of the lip rests on the inclined bottom arm 12 of the rail.

While the hanger could include only one rail or tooth 3, as shown in FIG. 10, by leaving spaces between the rails 3, the hanger can be used with receptacles having spaced apart reinforcing ribs 25 beneath the lip 22. When the receptacle 20 is placed on the hanger 1, the ribs 25 extend downwardly through the spaces between the rails 3.

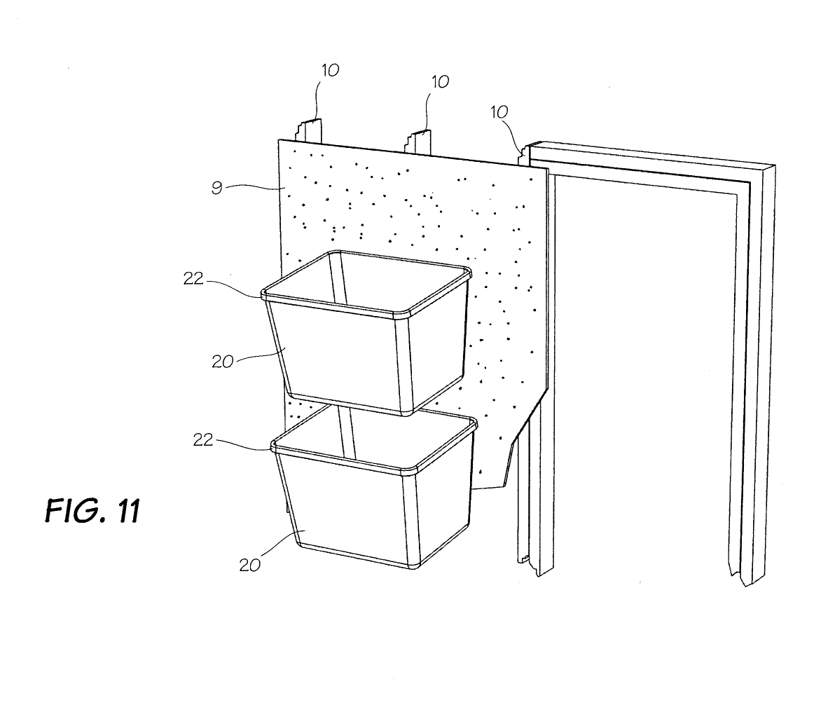

As shown in FIG. 11, two or more receptacles 20 can easily be vertically aligned on a wall 7 at any desired distance from the floor.

1. A receptacle hanger comprising:
(a) an elongated, planar body for mounting on a vertical surface; and
(b) at least one rail extending upwardly and outwardly from an upper end of said body for engaging a flange extending outwardly and downwardly from the receptacle, whereby the suspended receptacle is suspended from the hanger.

2. The receptacle hanger of claim 1 including a plurality of spaced apart rails extending outwardly and upwardly from said upper end of the body.

3. The receptacle hanger of claim 2, wherein each said rail includes an inclined bottom arm connected at one end to said upper end of the body and at a second end to a vertical arm, which is received by the flange of the receptacle.

4. The receptacle of claim 3 including reinforcing gussets extending between said bottom arm of each rail and the outer surface of said body.

5. The receptacle hanger of claim 4, wherein said body is trapezoidal and includes parallel upper and lower edges and downwardly and inwardly inclined side edges, said gussets on one side of center being parallel to one side edge and the gussets on the other side of center being parallel to the other side edge.

6. The receptacle hanger of claim 2 including a pair of vertically aligned fasteners receiving holes centrally located in said body, whereby a pair of fasteners can be inserted into a single vertical support member.

7. The receptacle hanger of claim 6, including additional fastener receiving holes on each side of said vertically aligned holes.
